(19) United States
(12) Patent Application Publication
(10) Pub. No.: US 2026/0101207 A1
(43) Pub. Date: Apr. 9, 2026

(54) LOCATION DETERMINATION IN WIRELESS NETWORKS USING MACHINE LEARNING

(71) Applicant: Hewlett Packard Enterprise Development LP, Spring, TX (US)

(72) Inventors: Siva Lingeswara Reddy Onteddu, Bangalore (IN); Sachin Shamrao Sanap, Bangalore (IN); Mayuri Pawar, Bangalore (IN); Akshay Ganesh Kini, Bangalore (IN); Naveen Holla, Bangalore (IN)

(21) Appl. No.: 18/982,588

(22) Filed: Dec. 16, 2024

(30) Foreign Application Priority Data
Oct. 7, 2024 (IN) 202441075801

(51) Int. Cl. H04W 24/08; H04W 24/02; H04W 64/00; H04W 84/12

(52) U.S. Cl. CPC H04W 24/08; H04W 24/02; H04W 64/003; H04W 84/12

(57) ABSTRACT

An example method for determining the distance between the network devices thereby enhancing the accuracy of location determination is presented. In one example implementation, the proposed method entails training, during a training phase, a machine learning (ML) model based on test environmental condition metrics about the network devices. Further, during an inference phase, a network controller may first determine a coarse distance between a pair of network devices using wireless signal strength between the pair of network devices, and then finetune the coarse distance to generate a refined distance using a trained ML model. Further, using the refined distance, the network controller may more accurately determine the location of a network device of the pair of network devices whose location was unknown.

### BACKGROUND

Wireless Fidelity (Wi-Fi®), hereinafter simply referred to as Wi-Fi, is a wireless networking protocol that allows a device to interface with the internet or with other nearby devices using radio waves. An access point (AP) is a networking device that allows Wi-Fi enabled devices (also referred to as network devices in the rest of the description) to connect to a wired network. An AP forms a wireless local-area network (WLAN) and functions as a central transmitter and receiver of wireless radio signals between network devices. In a WLAN, a plurality of APs may be available within a given area, and each AP may be positioned in a different location within the given area. To enable location-based services and to provide enhanced wireless connectivity to the network devices, it may be beneficial to know the location of network devices such as access points as well as the location of client devices including mobile devices such as cell phones, laptops, tablets, etc. as well as stationary devices such as the access points and other computing devices.

### BRIEF DESCRIPTION OF THE DRAWINGS

One or more examples in the present disclosure are described in detail with reference to the following Figures. The Figures are provided for purposes of illustration only and merely depict examples.

FIG. 1 depicts an example networked system in which various of the examples presented herein may be implemented.

FIG. 2 depicts a block diagram of an example network controller hosting a location management system.

FIG. 3 depicts a block diagram of an example computing system for training a machine learning (ML) model that may be used to infer a refined distance between network devices.

FIG. 4 depicts a flowchart of an example method for training an ML model.

FIG. 5 depicts a flowchart of an example method for determining a refined distance and using the refined distance to determine a location of a network device.

The Figures are not exhaustive and do not limit the present disclosure to the precise form disclosed.

### DETAILED DESCRIPTION

One approach to determining the location of the Wi-Fi enabled devices (hereinafter referred to as network devices) is to use a global positioning system (GPS). However, access to satellites enabling the GPS may be blocked (e.g., because the location is within a building), or the network device may not have that capability. Further, the GPS usage would be implemented and known by a network device and not an entity owning or controlling the property, such as interested parties in a shopping mall, a university campus, an enterprise business, an office building, a sporting or event complex, a hotel or other business, etc. Such an entity would not know the network device's position information unless the client shared the information. In the absence of a floor plan for a venue or location, it can be even more challenging for an entity to determine the location of the client devices.

Further, the use of wireless signal strength to determine the relative locations of network devices is also known, however, such techniques are prone to calculation errors due to several environmental factors that may affect the wireless signal strength. For instance, wireless signal strength may be determined as a received signal strength indicator (RSSI) between two network devices (e.g., two APs). As used herein, the term “RSSI” may be a measurement of the power present in a received radio signal. In some examples, RSSI may be indicative of the power level received by the radio after the antenna and possible cable loss. In some implementations, a receiving network device may determine the RSSI using a received wireless signal such as Bluetooth® Low Energy (BLE) beacon. Bluetooth® (hereinafter referred to as Bluetooth) is a technology useful for data transfers between devices. In particular, BLE may be a wireless personal area network technology that is designed to provide many of the features similar to Bluetooth, but with reduced power consumption and cost while still maintaining similar communication ranges as enabled by Bluetooth.

In the conventional techniques, once the RSSI between the two network devices is determined, a distance between the two network devices may be determined using the RSSI, for example by applying techniques such as a path-loss model and Kalman filtering. The locations (e.g., coordinate information) of the network devices may then be determined using triangulation, trilateration, or other similar techniques based on the distance between the two network devices. In certain cases, other information, such as floorplan boundaries (if available), can be used to supplement the RSSI information and coordinate information of APs to determine coordinate information about client devices.

In the above conventional technique, the determination of the distance using the RSSI information may play a key role as the accuracy of this conversion may determine how accurate the location determination will be at the final step. As will be understood, the signal strength may be affected by several parameters including but not limited to, environmental conditions and other external factors such as temperature, humidity, air pressure, signal absorption by physical objects such as building materials, and the like. This may in turn cause errors in RSSI calculations and impact the accuracy of location determination.

Hence improving the accuracy of the RSSI to distance conversion will be beneficial in accurately locating the network devices.

In accordance with the examples presented herein, presented is a method for more accurately determining the distance between the network devices thereby enhancing the accuracy of location determination. In one example implementation, the proposed method entails training, during a training phase, a machine learning (ML) model by inputting, to a network controller, location information and environmental condition metrics about the network devices. In some examples, the network devices may be BLE devices such as BLE-enabled client devices and/or BLE-enabled APs positioned at known locations in a network. The environmental condition metrics may be measurements of environmental condition parameters (also referred to as impacting parameters) such as, but not limited to, one or more of temperature, humidity, air pressure, and other factors such as length of the BLE beacon, building material where the device is observed and the count of the BLE devices observed at the location, an average packet error rate observed by the network devices (e.g., APs) on a floor, a total number of devices observed on the floor, or any other parameters that can cause interference for wireless signal. The network controller may be a networking device that may be communicatively coupled (e.g., via wired connections and/or wireless connections) to the network devices. In another example, the networking device may be implemented as a service or an application executing on a cloud platform.

Further, the network devices may also report signal strength (e.g., RSSI) values to the networking device. Based on the signal strength values, the networking device may estimate a preliminary distance between the two network devices, for example, a receiving network device and a transmitting network device. In one example, the networking device may implement path-loss based calculations and/or Kalman methods to determine the preliminary distance. Further, using an ML model (e.g., neural network), and based on the environment condition metrics and the estimated preliminary distance, the network controller may determine a finetuned preliminary distance between the two network devices. The finetuned preliminary distance may then be compared with an actual distance (a known distance) between the two network devices to identify any error and use this error information to update feature weights to be used in the ML model, thereby training the ML model.

In some examples, during runtime, the network controller may use the trained ML model to infer the distance between a first network device having a known location and a second network device whose location is unknown. The term “runtime” or “inference phase” as used herein may refer to a period during which the trained ML model is executing to infer outcomes (e.g., distances in this case). During the inference phase, the network controller may receive a runtime signal strength metric indicative of wireless signal power between a first network device and a second network device. The runtime signal strength metric may be a measure of wireless signal power during the inference phase.

Further, the network controller may receive runtime environmental condition metrics corresponding to one or both of the first and second network devices. The runtime environmental condition metrics may be information about the environmental conditions in the vicinity of the first network device and the second network device during the runtime. The runtime environmental condition metrics may be measurements of the environmental condition parameters (also referred to as impacting parameters) during the inference phase. Then, the network controller may determine a coarse distance between the first network device and the second network device based on the runtime signal strength metric. Furthermore, the network controller may determine a refined distance between the first network device and the second network device based on the coarse distance and the runtime environmental condition metrics using the ML model and the updated feature weights (e.g., the ones generated during the training phase). In some examples, the refined distance may be used to determine the location of the second network device based on a known location of the first network device.

Use of the ML model (e.g., neural network) to determine the refined distance between the network devices and using such refined distance to determine the location of the network devices may greatly improve the location determination accuracy. Accordingly, network devices such as BLE-enabled devices may benefit from a vast number of applications such as indoor positioning, asset tracking, pathfinding, proximity-based services, geofencing, and the like.

The following detailed description refers to the accompanying drawings. It is to be expressly understood that the drawings are for the purpose of illustration and description only. While several examples are described in this document, modifications, adaptations, and other implementations are possible. Accordingly, the following detailed description does not limit disclosed examples. Instead, the proper scope of the disclosed examples may be defined by the appended claims.

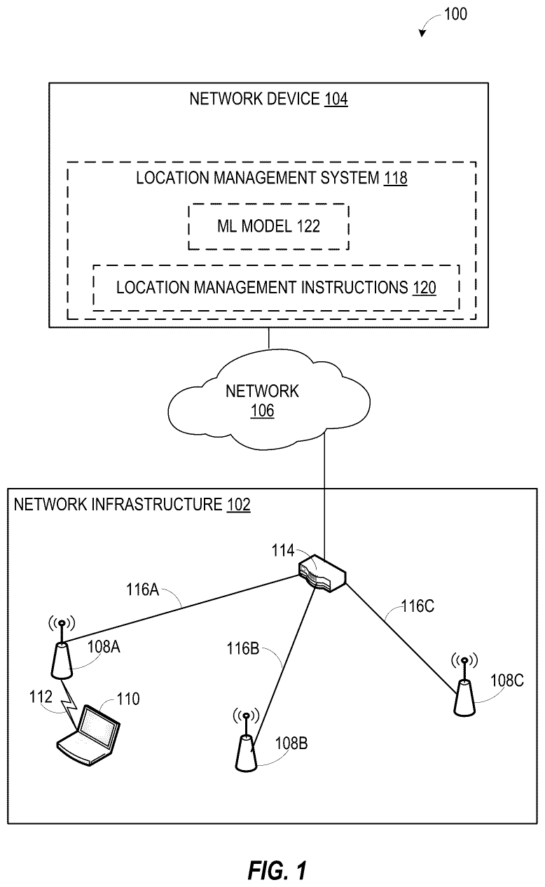

Before describing examples of the disclosed systems and methods in detail, it is useful to describe an example network installation with which these systems and methods might be implemented in various applications. FIG. 1 depicts an example networked system 100 in which various of the examples presented herein may be implemented. The networked system 100 may be implemented for any setup, for example, in a home setup or an organization, such as a business, educational institution, governmental entity, healthcare facility, or other organization. The networked system 100 may include a network infrastructure 102, or both the network infrastructure 102 and a network controller 104. In FIG. 1, although the network controller 104 is shown external to the network infrastructure 102, in some examples, the network controller 104 may be a part of the network infrastructure 102. In certain examples, the networking devices (e.g., access points, controllers, routers, etc.) deployed in the network infrastructure 102 may be configured to implement the functionalities of the network controller 104.

The network infrastructure 102 may be a small-scale network of devices or a large-scale network of devices. The small-scale network of devices may be a home network, for example. The large-scale network of devices may be an organization, university, public utility space (e.g., mall, airport, railway station, bus station, stadium, etc.), or office network hosting a large number of network devices, for example. The network infrastructure 102 may span across more than one site, for example, a room, a floor of a building, a building, or any other space that can host network devices. The network infrastructure 102 may be a private network, such as a network that may include security and access controls to restrict access to authorized users of the private network.

The network infrastructure 102 may include several network devices that communicate with each other and/or with any external device or system outside the network infrastructure 102. In the example implementation depicted in FIG. 1, the network infrastructure 102 is shown to include wireless networking devices, such as access points APs 108A, 108B, and 108C (hereinafter collectively referred to as APs 108A-108C); and one or more wireless-enabled (e.g., Wi-Fi enabled) client devices, for example, a client device 110. The APs 108A-108C may generally be deployed at respective fixed locations in the network infrastructure 102, whereas the client device 110 may be mobile (e.g., tablets, smartphones, laptops, etc.) or be positioned at fixed locations (e.g., desktop computers, televisions, etc.). Further, in some examples, the network infrastructure 102 may optionally include a local controller 114 that is in communication with an external network 106. It is to be noted that the examples presented herein are not limited by the specifics (e.g., types and counts) of the devices depicted in FIG. 1. In some examples, the APs 108A-108C, the client device 110, and the local controller 114 may be configured to communicate other devices using wireless communication techniques specified in one or more Institute of Electrical and Electronics Engineers (IEEE) 802.11 standard specifications. In some examples, the network devices such as the APs 108A-108C, and the client devices may be capable of communicating via protocols such as Bluetooth or BLE.

The networking devices, for example, the APs 108A-108C may act as a point of access to a local network established in the network infrastructure 102 and/or the external network 106 for any client devices in the network infrastructure 102. For example, in the implementation depicted in FIG. 1A, the client device 110 is shown as connected to the AP 108A via a wireless communication link 112. Accordingly, the client device 110 may communicate with any other devices (inside the network infrastructure 102 or outside the network infrastructure 102) via the AP 108A. The wireless communication link 112 may be established in compliance with any of the IEEE 802.11 Standards. Further, in some examples, the wireless communication link 112 may be established in compliance with the Bluetooth or BLE Standards.

A wireless networking device, such as any of the APs 108A-108C, may be a combination of hardware, software, and/or firmware configured to provide wireless network connectivity to the client device 110. The wireless networking devices may communicate with the client devices in accordance with one or more IEEE 802.11 standard specifications. In some examples, the APs 108A-108C may be implemented with one or more radios to help the APs 108A-108C communicate with the respective client devices and other wireless-capable devices. Each radio may operate on a respective range of radio frequency ranges, referred to as a Wi-Fi band, for example, the 2.4 GHz Wi-Fi band, 5 GHz Wi-Fi band, the 6 GHz Wi-Fi band, and so on.

Further, in some examples, although not shown, the network infrastructure 102 may include one or more sensors deployed at various places and capable of measuring one or more of the environmental condition parameters in the network infrastructure. For instance, such sensors may include sensors that are capable of measuring environmental condition parameters such as, but not limited to, one or more of temperature, humidity, air pressure, and other factors such as length of the BLE beacon, building material where the device is observed and the count of the BLE devices observed at the location, an average packet error rate observed by the network devices (e.g., APs 108A-108C) on a floor, a total number of devices observed on the floor, or any other parameters that can cause interference for wireless signal. Once measured, periodically or on demand, the sensors may report the respective values as the environmental condition metrics (e.g., test environmental condition metrics during a training phase and runtime environmental condition metrics during an inference phase) to the network controller 104. Furthermore, in certain examples, the networking devices such as the APs 108A-108C and the client device 110 may be equipped with sensors capable of measuring the environmental condition parameters. Accordingly, the networking devices may use such local sensors to monitor the environmental condition parameters and report the measured values as the environmental condition metrics to the network controller.

The network 106 may be a public or private network, such as the Internet, or another communication network to allow connectivity between the network infrastructure 102 and the network controller 104. The network 106 may include third-party telecommunication lines, such as phone lines, broadcast coaxial cables, fiber optic cables, satellite communications, cellular communications, and the like. In some examples, the network 106 may include any number of intermediate network devices, such as switches, routers, gateways, servers, and/or controllers, which are not directly part of the network infrastructure 102 but that facilitate communication between the various parts of the network infrastructure 102, and between the network infrastructure 102 and any other network-connected entities.

The APs 108A, 108B, and 108C may communicate with the local controller 114 over respective connections, for example, the connections 116A, 116B, and 116C, which may include wired and/or wireless interfaces. The local controller 114 may provide communication with the network 106 for the network infrastructure 102, though it may not be the only point of communication with the network 106 for the network infrastructure 102. In some examples, the local controller 114 may communicate with the network 106 through a router (not shown). In other implementations, the local controller 114 may provide router functionality to the devices in the network infrastructure 102. In some examples, the local controller 114 may be a wireless local area network (WLAN) controller. The local controller 114 may be operable to configure and manage network devices, such as at the network infrastructure 102, and may also manage network devices at other remote sites, if any, within the network infrastructure 102. The local controller 114 may be operable to configure and/or manage switches, routers, access points, and/or client devices connected to a network. The local controller 114 may itself be, or provide the functionality of, an AP.

The examples of client device 110 may include desktop computers, laptop computers, servers, web servers, authentication servers, authentication-authorization-accounting (AAA) servers, Domain Name System (DNS) servers, Dynamic Host Configuration Protocol (DHCP) servers, Internet Protocol (IP) servers, Virtual Private Network (VPN) servers, network policy servers, mainframes, tablet computers, e-readers, netbook computers, televisions and similar monitors (e.g., smart TVs), content receivers, set-top boxes, personal digital assistants (PDAs), mobile phones, smartphones, virtual terminals, video game consoles, virtual assistants, Internet-of-Things (IoT) devices, and the like. While some client devices may remain stationary or deployed at the fixed locations, some client devices may be portable and can be moved from one location to another in the network infrastructure 102.

To enable location-based services, such as but not limited to, indoor positioning, asset tracking, pathfinding, proximity-based services, and the like; and to provide enhanced wireless connectivity to the network devices (e.g., the client devices such as the client device 110), it may be beneficial to know the location of network devices such as access points as well as the location of client devices. Certain existing methods of location determination based using RSSI information may suffer from inaccuracies in the location determination caused by the inaccurate determination of distances between the network devices. In particular, the signal strength may be affected by several parameters including but not limited to, environmental conditions and other external factors such as temperature, humidity, air pressure, signal absorption by physical objects such as building materials, an average packet error rate observed by the network devices (e.g., APs) on a floor, a total number of devices observed on the floor, and the like. The fluctuations in signal strength may cause errors in RSSI calculations which may negatively impact the accuracy of location determination.

To that end, the network controller 104 may aid in determining the locations of the network devices for example the client device 110 more accurately by obviating the adverse effects of the impacting parameters on the distance calculations. The network controller 104 may be deployed in a public, private, or hybrid cloud outside the network infrastructure 102. In some examples, the network controller 104 may be implemented as one or more computing systems, for example, computers, controllers, servers, or storage systems. In certain examples, the network controller 104 may be an electronic device having a hardware processing resource, such as one or more central processing units (CPUs), semiconductor-based microprocessors, and/or other hardware devices suitable for retrieval and execution of instructions (e.g., location management instructions 120). In certain other examples, the network controller 104 may be implemented as a software resource, such as a software application, a virtual machine (VM), a container, a containerized application, or a pod. In some examples, the network controller 104 may be implemented as a service running on a “cloud computing” environment or as a “software as a service” (SaaS). The network controller 104 and/or the functionalities implemented via the network controller 104 may be offered as a stand-alone product/service or a packaged solution that can be utilized on a one-time full product/solution purchase or pay-per-use basis.

In certain other examples, not shown in FIG. 1, the network controller 104 may be deployed within the network infrastructure 102. In such an implementation, the network controller 104 may be connected to the local controller 114 and/or the APs 108A-108C. In some other examples, the local controller 114 may be configured to implement the functionalities of the network controller 104, in such cases the local controller 114 may be construed as the network controller.

In accordance with the examples presented herein, the network controller 104 may host a location management system 118 by way of a processing resource executing the location management instructions 120 stored in a machine-readable medium of the network controller 104. For illustration purposes, the location management system 118 and the location management instructions 120 are represented by the dashed outline as they represent digital entities in the form of data and/or instructions that are executable by a physical processing resource, for example, a processor. By way of executing the location management instructions 120, the location management system 118 may accurately determine the distance between two networking devices and use such distance to determine the location of one or more of the networking devices. In particular, the proposed network controller 104 leverages a machine learning (ML) model 122 that is trained based on signal strengths between the networking devices (e.g., APs 108A-108C that are deployed at the fixed locations within the network infrastructure 102) and environment conditions in the vicinity of the network devices.

In some examples, the ML model 122 may be implemented as a neural network or a deep neural network. Neural networks are a type of machine learning model inspired by the structure and function of the human brain. It consists of interconnected artificial neurons (also known as nodes or units) that are organized in layers. Each neuron takes inputs, performs a computation, and produces an output, which is then passed to other neurons in subsequent layers. Neural networks are designed to learn and adapt from data, making them a fundamental component of machine learning and deep learning. The deep neural network is a subset of the neural networks that comprises multiple hidden layers.

Accordingly, in some examples, the ML model 122 may include one or more processing layers, one or more input neurons, and one or more output neurons. Each of the processing layers, input neurons, and output neurons may include a virtual or a physical data processing resource that may receive feature weights and input parameters (e.g., signal strength metrics, environmental condition metric, etc.) and a corresponding outcome. A hidden layer may be implemented in between the input and output layers and uses generated parameters by using the previous layer, here previous layer can be one of the hidden layers or the input layer. The output layer may provide a calculated output. This calculated output may be compared against the actual output, and the weights of the input parameters may be adjusted based on the comparison. This trained model may be used to predict the newer inputs where actual outputs are unknown during an inference phase.

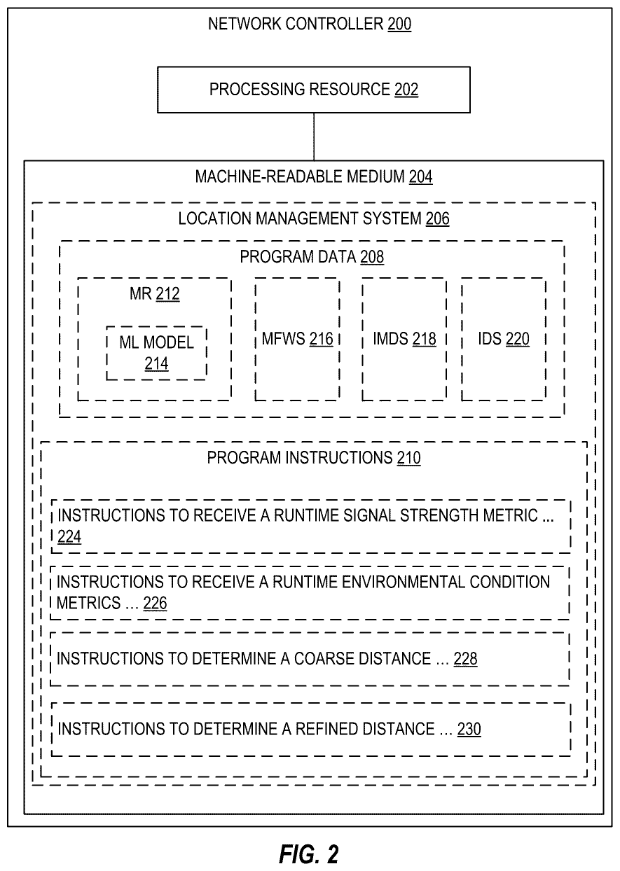

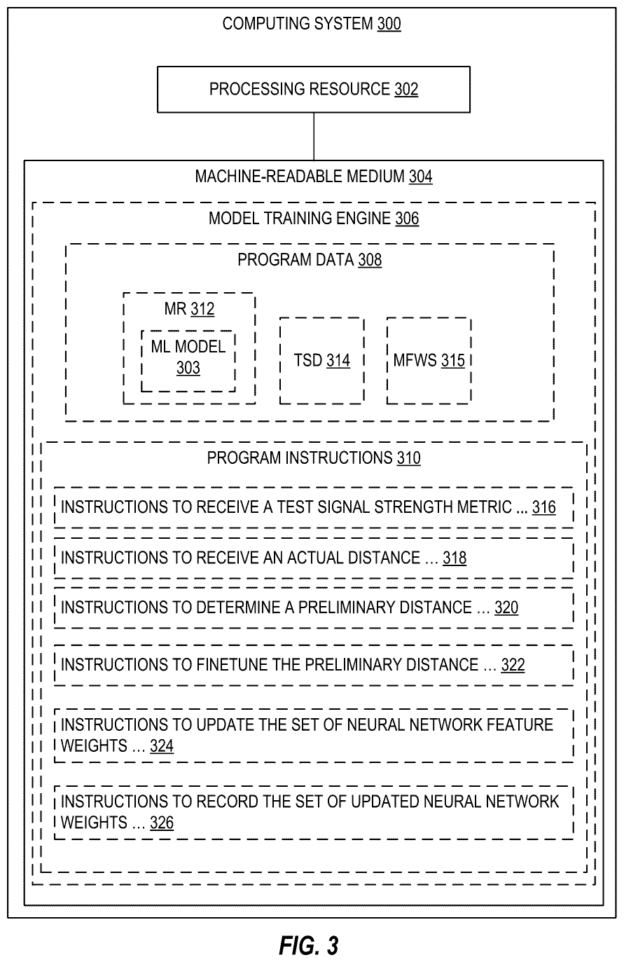

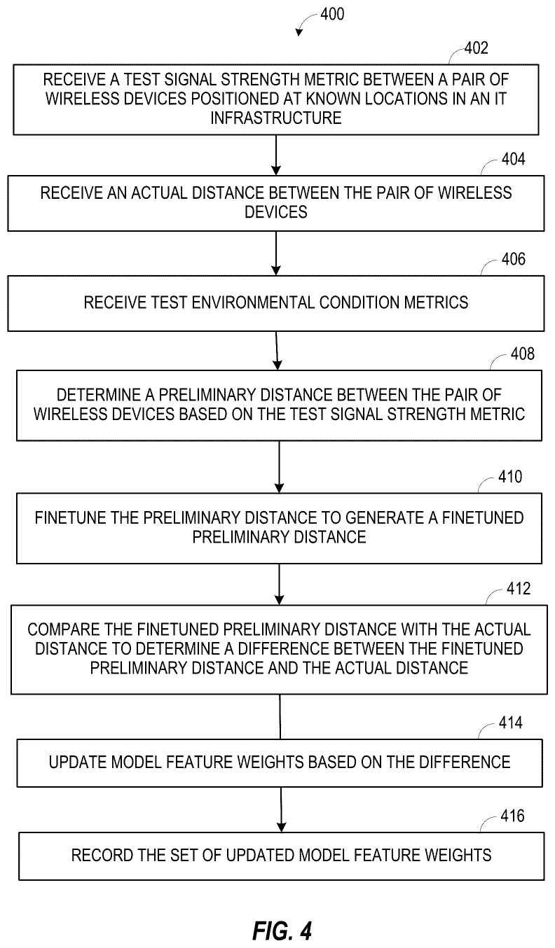

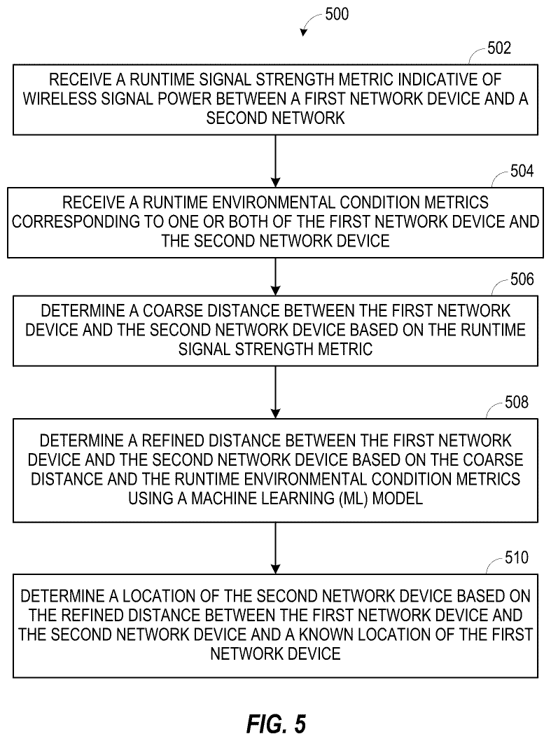

The trained ML model 122 when executed by the processor of the network controller 104 may aid the network controller 104 in determining distances between the network devices and the client devices with increased accuracy compared to conventional techniques. Additional details about the example network controller and a computing system to train the ML model 122 are described in conjunction with the block diagrams of FIGS. 2 and 3. Further, an example method for training the ML model 122 is described in conjunction with the flow diagram of FIG. 4, and an example method of location determination using the ML model 122 is described in conjunction with the flow diagram of FIG. 5.

Referring now to FIG. 2, a block diagram of an example network controller 200 is presented. The network controller 200 of FIG. 2 may be an example representative of the network controller 104 of FIG. 1. In particular, the network controller 200 is configured to aid in the location determination of the network devices, for example, the client devices within a network infrastructure, for example, the network infrastructure 102 of FIG. 1. More particularly, the network controller 200 is configured to determine a refined distance between two network devices and use such refined distance to determine the location of the network devices. In some examples, to enable such a determination of the refined distance and the location of the network devices, the network controller 200 implements a location management system 206. For illustration purposes, the location management system 206 and items inside the location management system 206 are represented with the dashed outline as they represent digital entities which may be in the form of data and/or instructions that are executable by a physical processing resource, for example, the processing resource 202.

The network controller 200 may include a processing resource 202 and/or a machine-readable storage medium 204 for the network controller 200 to execute several operations as will be described in the greater details below.

The processing resource 202 may be a physical device, for example, a central processing unit (CPU), a microprocessor, a graphics processing unit (GPU), a field-programmable gate array (FPGA), application-specific integrated circuit (ASIC), other hardware devices capable of retrieving and executing instructions stored in the machine-readable storage medium 204, or combinations thereof. In one example, the processing resource 202 may fetch, decode, and execute the instructions stored in the machine-readable storage medium 204 to accomplish several operations intended to be performed by the network controller 200. As an alternative or in addition to executing the instructions, the processing resource 202 may include at least one integrated circuit (IC), control logic, electronic circuits, or combinations thereof that include a number of electronic components for performing the functionalities intended to be performed by the network controller 200.

The machine-readable storage medium 204 may be non-transitory and is alternatively referred to as a non-transitory machine-readable storage medium that does not encompass transitory propagating signals. The machine-readable storage medium 204 may be any electronic, magnetic, optical, or another type of storage device that may store data and/or executable instructions. Examples of the machine-readable storage medium 204 may include RAM, NVRAM, EEPROM, a storage drive (e.g., SSD or HDD), a flash memory, and the like. The machine-readable storage medium 204 may be encoded with the location management system 206 which aids in determining the refined distance between the network devices and using this refined distance determining the location between the network devices.

The location management system 206 includes program data 208 and program instructions 210. The program data 208 may store a variety of data that may be received, used, and/or generated by the processing resource 202 as the processing resource 202 executes the program instructions 210. By way of example, the program data 208 may include a model repository (MR) 212 that stores the ML model 214, a model feature weights store (MFWS) 216, an impacting parameter data store (IMDS) 218 storing runtime environmental condition metric data, and an inference data store (IDS) 220 that may store refined distances inferred using the ML model 214 based on a coarse distance between the networking devices, the model feature weights, and the runtime environmental condition metric data. The ML model 214 may be an example representative of the ML model 122 of FIG. 1. While for illustration purposes, several types of data are shown as stored separately in respective repositories and data stores in FIG. 2, in some examples, one or more types of data noted hereinabove may be stored in a common repository or data store, without limiting the scope of the present disclosure.

Further, in accordance with examples consistent with the present disclosure, the network controller 200 may execute the location management system 206, by way of the processing resource 202 executing the program instructions 210, to determine the refined distance between the network devices and use the refined distance to determine the location between the network devices. In particular, in some examples, the processing resource 202 may execute one or more of the program instructions 210 to perform the method steps described in conjunction with FIG. 5. For example, the program instructions 210 may include instructions 224, 226, 228, and 230.

The instructions 224 when executed by the processing resource 202 may cause the processing resource 202 to receive a runtime signal strength metric indicative of wireless signal power between a first network device (e.g., the AP 108A) and a second network device (e.g., the client device 110) deployed a network infrastructure (e.g., the network infrastructure 102). Further, the instructions 226, when executed by the processing resource 202, may cause the processing resource 202 to receive runtime environmental condition metrics corresponding to one or both of the first network device and the second network device. Furthermore, the instructions 228, when executed by the processing resource 202, may cause the processing resource 202 to determine a coarse distance between the first network device and the second network device based on the runtime signal strength metric. Moreover, the instructions 230, when executed by the processing resource 202, may cause the processing resource 202 to determine a refined distance between the first network device and the second network device based on the coarse distance and the runtime environmental condition metrics using the ML model 214. As will be described in greater detail in conjunction with FIG. 4, an ML model such as the ML model 214 is trained to infer the refined distance based at least on a set of test environmental condition metrics corresponding to a set of network devices installed at known locations in the Network infrastructure.

Although not shown, in some examples, the machine-readable storage medium 204 may be encoded with certain additional executable instructions to perform any other operations performed by the network controller 200, without limiting the scope of the present disclosure. For example, the machine-readable storage medium 204 may be encoded with instructions which when executed by the processing resource 202 may cause the processing resource to determine the location of the second network device based on the refined distance between the first network device and the second network device and a known location of the first network device. Additional details about a method for determining the refined distance between the network devices and using the refined distance to determine the location of the network devices are described in conjunction with a method described in FIG. 5.

Referring now to FIG. 3, a block diagram of an example computing system 300 that aids in training an ML model, for example, the ML model 303. The ML model 303 when trained may be deployed as the ML model 122 in the network controller 104 of FIG. 1 or the ML model 214 in the network controller 200 of FIG. 2. The computing system 300 may be deployed inside a network infrastructure, such as the network infrastructure 102, or outside the network infrastructure 102. For example, a network controller such as the network controller 104 may be configured to function as the computing system 300. In certain examples, a local controller such as the local controller 114 may be configured to function as the computing system 300. Furthermore, in some examples, devices such as desktop computers, laptop computers, servers, web servers, authentication servers, AAA servers, DNS servers, DHCP servers, IP servers, VPN servers, network policy servers, mainframes, tablet computers, e-readers, netbook computers, televisions and similar monitors (e.g., smart TVs), content receivers, set-top boxes, PDAs, mobile phones, smartphones, smart terminals, dumb terminals, virtual terminals, video game consoles, virtual assistants, IoT devices, and the like, may be used as the computing system 300 to train the ML model 303.

In some examples, to accomplish the task of training the ML model 303, the computing system 300 implements a model training engine 306. For illustration purposes, the model training engine 306 and items inside the model training engine 306 are represented with the dashed outline as they represent digital entities which may be in the form of data and/or instructions that are executable by a physical processing resource, for example, the processing resource 302. In particular, to aid in the task of model training, the computing system 300 may include the processing resource 302 and a machine-readable storage medium 304. The processing resource 302 and the machine-readable storage medium 304 may be example representatives of the processing resource 202 and the machine-readable storage medium 204 of FIG. 2, certain details of which are not repeated herein for the sake of brevity.

The machine-readable storage medium 304 may be encoded with the model training engine 306 which aids in training the ML model 303. The model training engine 306 includes program data 308 and program instructions 310. The program data 308 may store a variety of data that may be received, used, and/or generated by the processing resource 302 as the processing resource 302 executes the program instructions 310. By way of example, the program data 308 may include a model repository (MR) 312 storing the ML model 303, a training data store (TDS) 314, and a model feature weight store (MFWS) 315. The training data store 314 may store a training dataset useful to train the model 303. For example, the training dataset may include test signal strength metrics and test environmental condition metrics received by the computing system 300 during the training phase. Further, the model feature weight store 315 may store values of the model feature weights as recorded by the processing resource 302 during the training phase.

In accordance with examples consistent with the present disclosure, the computing system 300 may execute the model training engine 306, by way of the processing resource 302 executing the program instructions 310. In particular, in some examples, the processing resource 302 may execute one or more of the program instructions 310 to perform the method steps described in conjunction with FIG. 5. For example, the program instructions 310 may include instructions 316, 318, 320, 322, 324, and 326. In particular, the instructions 316 when executed by the processing resource 302 may cause the processing resource 302 to receive a test signal strength metric between a pair of network devices (e.g., the AP 108A and the AP 108B) positioned at known locations in a network infrastructure (e.g., the network infrastructure 102 of FIG. 1). Further, the instructions 318 when executed by the processing resource 302 may cause the processing resource 302 to receive an actual distance between the pair of network devices.

Furthermore, the instructions 320 when executed by the processing resource 302 may cause the processing resource 302 to determine a preliminary distance between the pair of network devices based on the test signal strength metric. Moreover, the instructions 322 when executed by the processing resource 302 may cause the processing resource 302 to finetune the preliminary distance to generate a finetuned preliminary distance using a neural network, a set of test environmental condition metrics, and a set of neural network weights. Furthermore, the instructions 324 when executed by the processing resource 302 may cause the processing resource 302 to update the set of neural network feature weights to generate a set of updated neural network weights based on a difference between the actual distance and the finetuned preliminary distance. Additionally, the instructions 326 when executed by the processing resource 302 may cause the processing resource 302 to record the set of updated neural network weights.

Although not shown, in some examples, the machine-readable storage medium 304 may be encoded with certain additional executable instructions to perform any other operations performed by the computing system 300 to aid in the training of the ML model 303, without limiting the scope of the present disclosure.

Turning now to FIG. 4 a flowchart of an example method 400 for training an ML model (e.g., the ML model 122) based on environmental condition metrics to infer a refined distance between the network devices is presented. The steps shown in FIG. 4 may be performed by any suitable device, such as a network controller 104 or the local controller 114 shown in FIG. 1, or the network controller 200 of FIG. 2. In some other examples, the steps shown in FIG. 4 may be performed by any general-purpose or special-purpose computing system capable of executing instructions. In certain examples, the method of FIG. 4 may be performed by a computing system such as the computing system 300 of FIG. 3.

In the description hereinafter, for illustration purposes, the method of FIG. 4 is described as being performed by the computing system 300 of FIG. 3. In some examples, the suitable device may include a processing resource suitable for retrieval and execution of instructions stored in a machine-readable storage medium. The processing resource and the machine-readable storage medium may be example representatives of the processing resource 302 and the machine-readable storage medium 304 described in conjunction with FIG. 3. As an alternative or in addition to retrieving and executing instructions, the processing resource may include one or more electronic circuits that include electronic components for performing the functionality of one or more instructions, such as an FPGA, ASIC, or other electronic circuits.

A computing system, for example, the computing system 300 of FIG. 3 may be configured to execute the method 400, during a training phase, to train an ML model such as the ML model 303 using training data so that such a trained ML model such as the ML model 122 may be used by a networked device such as the network controller 104, 200, during an inference phase, to infer refined distance between network devices in an infrastructure (e.g., network infrastructure 102). The term training phase as used herein may refer to a period during which the ML model such as the ML model 303 may be trained based on a training dataset (e.g., data comprising test signal strength metrics and test environment condition metrics) thereby generating a trained model such as the trained ML model 122 or the ML model 214. Further, while the method for training the ML Model described in FIG. 4 illustrates examples corresponding to a specific pair of network devices (e.g., the APs 108A and 108B), similar method steps may be performed for other additional network device pairs (e.g., a pair of APs 108A and 108C; and a pair of APs 108B and 108C) to train the ML model.

Accordingly, in the training phase, at step 402, the computing device may receive a test signal strength metric between a pair of network devices positioned at known locations in the infrastructure. For example, the pair of network devices positioned at known locations may be the access points such as the APs 108A and 108B. While several examples described herein are with respect to the AP pair containing the APs 108A and 108B, other AP pairs may be used instead or in addition to the APs 108A and 108B. As previously noted, the APs may be located at the fixed locations in the network infrastructure, and information related to such devices may be used to train the ML model. For instance, any of the APs 108A and 108B may report a test signal strength metric between the APs 108A and 108B. For the given example of the APs 108A and 108B, the test signal strength metric may be a value of the RSSI of a wireless signal that the AP 108A receives from AP 108B, or vice versa, during the training phase. By way of example, the AP 108A may determine the test signal strength metric based on the beacon signals (e.g., BLE beacons) that the AP 108A receives from the AP 108B. It may be noted that the test signal strength metric may also be determined based on other data signals or management signals (e.g., IEEE 802.11 management frames).

Further, in addition to receiving the test signal strength metric, the computing system, at step 404, may also receive an actual distance between the pair of network devices. As previously noted, the APs are positioned at fixed locations in the network infrastructure. Accordingly, in some examples, the APs would have already determined their relative distances with respect to the other APs in the network infrastructure, for example, using ranging techniques such as the Fine Timing Measurement (FTM) described in IEEE 802.11 Standard Specification. Accordingly, at step 404, the AP 108A may send its relative distance with respect to the AP 108B as the actual distance between the APs 108A and 108B to the computing system.

In another example, as the APs in the network infrastructure are positioned at fixed locations, a network administrator may have determined (e.g., using a floor plan or by conducting physical onsite measurements) or might have been aware of the actual physical distances between each AP pair in the network infrastructure. Accordingly, in some examples, the network administrator may input such distances as the actual distances between each pair (including the AP pair 108A and 108B) to the computing system using a suitable user interface enabled by the computing system.

Furthermore, at step 406, the computing system may receive a set of test environmental condition metrics corresponding to one or both of the pair of network devices. The set of test environmental condition metrics may be measurements of environmental condition parameters (also referred to as impacting parameters) such as, but not limited to, temperature, humidity, air pressure, and other factors such as length of the BLE beacon, building material where the device is observed, an average packet error rate observed by the network devices (e.g., APs) on a floor, a total number of devices observed on the floor, or any other parameters that can cause interference for wireless signal, during the training phase. In some examples, an operator such as the network administrator may input the values of the environmental condition metrics using a suitable user interface enabled by the computing system. In certain other examples, several sensors capable of measuring one or more of the environmental condition parameters may be deployed at various places in the network infrastructure. Such sensors may monitor the respective environmental condition parameters and report the respective values as the environmental condition parameters. The computing system may store the values of the test environmental condition parameters received during the training phase as the test environmental condition metrics.

Furthermore, at step 408, the computing system may determine a preliminary distance between the pair of network devices based on the test signal strength metric. The preliminary distance may be a coarse distance that may have a certain margin of error (e.g., ±10%) due to disturbances in the signal communication caused by surroundings. For example, the computing system may determine a preliminary distance between the APs 108A and 108B based on the test signal strength metric determined at step 402. By way of example, the computing system may determine the preliminary distance as Dp (in meters) using the example relationship shown in Equation 1 represented below.

$$Dp = 1 {0}^{( \frac{SP 1 - TestRSSI}{10 * FF 1} )} \qquad Equation ( 1 )$$

Wherein, SP1 represents a first standard power which is an RSSI value at a location 1 meter away from a transmitting network device (e.g., the AP 108B in this case) of the pair of networking devices. If the value of SP1 is unknown, SP1 may be set to a default value (e.g., −45). Further, TestRSSI represents the test signal strength metric received at step 402, and FF1 represents a fading factor which may be a predefined or a customizable numerical value indicative of an impact of fluctuations in the wireless signal transmission due to surroundings. In some examples, FF1 may be set to 2 (two). For example, if the values of SP1, TestRSSI, and FF1, are −68, −75, and 2, respectively, the preliminary distance Dp may be determined as 2.238 meters. It may be noted that the above example calculation of the preliminary distance is for illustration purposes. The computing system is envisioned to implement any suitable technique to determine the preliminary distance without limiting the scope of the present disclosure.

Moreover, at step 410, the computing system may finetune the preliminary distance to generate a finetuned preliminary distance using an ML model (e.g., a neural network). The model is configured to increase or decrease the preliminary distance based on the test environmental condition metrics and a set of model feature weights (e.g., neural network weights). To enable this, the computing system may provide information such as the preliminary distance between the pair of network devices, the set of test environmental condition metrics, and a set of neural network weights as inputs to the ML model. In some examples, for the first instance of the finetuning using the ML model, the set of model feature weights may be predefined fixed values and are stored in a model feature weight store (e.g., the model feature weight store 315). Based on the provided inputs, the ML model may output the finetuned preliminary distance. For the example mentioned earlier wherein Dp was determined as 2.238 meters, the finetuned preliminary distance may be calculated as 2.1 meters using the ML model based on the based on the test environmental condition metrics and a set of model feature weights.

Additionally, at step 412, the computing system may compare the finetuned preliminary distance (generated at step 410) with the actual distance (received at step 404) to determine a difference between the finetuned preliminary distance and the actual distance.

Further, at step 414, the computing system may update one or more of the set of model feature weights based on the difference between the finetuned preliminary distance and the actual distance to generate a set of updated model feature weights. In some examples, if the computing system determines that the difference is outside a predefined range, the computing system may update the set of model feature weights based on the magnitude of the difference indicating how close the finetuned preliminary distance is to the actual distance. The predefined range may be customizable and be specified by the administrator. For example, the predefined range may be set to ±500 centimetres (cm). In particular, an amount of the change that may be made to the model feature weights may be a function of the difference between the finetuned preliminary distance and the actual distance. For example, the magnitude of the change may be directly or indirectly proportional to the difference between the finetuned preliminary distance and the actual distance. In some examples, if it is determined that the difference is within the predefined range, the computing system may not update the set of model feature weights.

Furthermore, at step 416, the computing system may record the set of updated model feature weights. In some examples, the computing system may replace/overwrite the previous values of the model feature weights with the set of updated model feature weights in the model feature weight store 315.

Turning now to FIG. 5 a flowchart of an example method 500 for determining the distance between two networking devices and using this distance to determine the location of one of the network devices is presented. The steps shown in FIG. 5 may be performed by any suitable device, such as a network controller 104 or the local controller 114 shown in FIG. 1, or the network controller 200 of FIG. 2. In some other examples, the steps shown in FIG. 5 may be performed by any general-purpose or special-purpose computing system capable of executing instructions. In particular, for illustration purposes, the method of FIG. 5 is described as being performed by a network controller such as the network controller 104 of FIG. 1 or the network controller 200 of FIG. 2. In some examples, the suitable device may include a processing resource suitable for retrieval and execution of instructions stored in a machine-readable storage medium. The processing resource and the machine-readable storage medium may be example representatives of the processing resource 202 and the machine-readable storage medium 204 described in conjunction with FIG. 2. As an alternative or in addition to retrieving and executing instructions, the processing resource may include one or more electronic circuits that include electronic components for performing the functionality of one or more instructions, such as an FPGA, ASIC, or other electronic circuits.

The network controller may execute the method 500 during the runtime, also referred to as an inference phase. The terms “runtime” or “inference phase” as used herein may refer to a period during which the trained ML model is executed to infer outcomes. In particular, the network may, during the inference phase, use the trained ML model such as the ML model 122 (e.g., an ML model trained using the method of FIG. 4) to infer a refined distance between two network devices (e.g., the AP 108A and the client device 110), and use such refined distance to determine the location of the client device 110. For the purpose of illustration in FIG. 5, network devices such as the APs (e.g., an AP 108A) are considered as positioned at respective known locations in the network infrastructure (e.g., the network infrastructure 102), and the location of the client device (e.g., the client device 110) may be unknown. To that end, the network controller may be configured to execute the method 500 to determine the distance between the AP and the client device and use the refined distance determined using the ML model to identify the location of the client device.

In particular, at step 502, the network controller may receive a runtime signal strength metric indicative of wireless signal power between a first network device (e.g., the AP 108A) and a second network device (e.g., the client device 110) in a network infrastructure (e.g., the network infrastructure 102). For the given example of the APs 108A and 108B, the runtime signal strength metric may be a value of the RSSI of the wireless signal that the first network device receives from the second wireless device, or vice versa, during runtime. By way of example, the first network device may determine the runtime signal strength metric based on the beacon signals (e.g., BLE beacons) that the first network device receives from the second network device. It may be noted that the runtime signal strength metric may also be determined based on other data signals or management signals (e.g., IEEE 802.11 management frames).

Further, at step 504, the network controller may receive runtime environmental condition metrics corresponding to one or both of the first network device and the second network device. The runtime environmental condition metrics may be measurements of environmental condition parameters (also referred to as impacting parameters) such as, but not limited to, temperature, humidity, air pressure, and other factors such as length of the BLE beacon, building material in the vicinity of the one or both of the first network device and the second network device, during the inference phase. In some examples, several sensors capable of measuring one or more of the environmental condition parameters may be deployed at various places in the network infrastructure. Such sensors may monitor the respective environmental condition parameters and report the respective values as the runtime environmental condition metrics to either the network controller or the first networking device. The first networking device may then forward the runtime environmental condition metrics to the network controller.

In certain other examples, the first networking device may be equipped with sensors capable of measuring the environmental condition parameters. Accordingly, the first networking device may use such local sensors to monitor the environmental condition parameters and report the measured values as the runtime environmental condition metrics to the network controller. The network controller may store the runtime environmental condition metrics and impacting parameters data store.

Furthermore, at step 506, the network controller may determine a coarse distance between the first network device and the second network device based on the runtime signal strength metric. The coarse distance may be calculated in a similar fashion as determining the preliminary distance at step 406 in method 400 and may have a certain margin of error (e.g., ±10%) due to disturbances in the signal communication caused by surroundings as such disturbances are not accounted in the calculation of the coarse distance. By way of example, the computing system may determine the coarse distance as Dc (in meters) using the example relationship shown in Equation 2 represented below.

$$Dc = {10}^{( \frac{SP 2 - RuntimeRSSI}{10 * FF 1} )} \qquad Equation ( 2 )$$

Wherein, SP2 represents a second standard power which is an RSSI value at a location 1 meter away from a transmitting network device (e.g., the client device 110 in this case). If the value of SP2 is unknown, SP2 may be set to a default value (e.g., −45). Further, RuntimeRSSI represents the runtime signal strength metric received at step 502, and FF2 represents a fading factor which may be a predefined or a customizable numerical value indicative of an impact of fluctuations in the wireless signal transmission due to surroundings. In some examples, FF2 may be set to 2 (two).

It may be noted that the above example calculation of the preliminary distance is for illustration purposes. The computing system is envisioned to implement any suitable technique to determine the preliminary distance without limiting the scope of the present disclosure.

Moreover, at step 508, the network controller may determine a refined distance between the first network device and the second network device based on the coarse distance (determined at step 506) and the runtime environmental condition metrics (received at step 504) using an ML model (e.g., the ML model 122 or 214). The ML model might have been trained to finetune the preliminary distance based at least on the set of test environmental condition metrics. In particular, during the inference phase, at step 508, the ML model may finetune the coarse distance based on the runtime environmental condition metrics and the set of updated model feature weights (e.g., the model feature weights recorded at step 414 of method 400). The finetuned coarse distance during the inference phase is referred to as the refined distance. Once determined, the refined distance may be stored in an inference data store, such as the inference data store 220 shown in FIG. 2.

As previously noted, the location of the first network device may be known. Accordingly, in some examples, at step 510, the network controller may use the refined distance determined at step 508 to determine the location of the second network device. It may be noted that the scope of the present disclosure is not limited with respect to a technique of determining the location. By way of example, the network controller may implement techniques such as triangulation, trilateration, or a combination thereof to determine the location of the second network device using the refined distance and the known location of the first network device.

Terms and phrases used in this document, and variations thereof, unless otherwise expressly stated, should be construed as open-ended as opposed to limiting. As examples of the foregoing, the term “including” should be read as meaning “including, without limitation” or the like. The term “example” is used to provide exemplary instances of the item in the discussion, not an exhaustive or limiting list thereof. The terms “a” or “an” should be read as meaning “at least one,” “one or more” or the like. The presence of broadening words and phrases such as “one or more,” “at least,” “but not limited to” or other like phrases in some instances shall not be read to mean that the narrower case is intended or required in instances where such broadening phrases may be absent. Further, the term “and/or” as used herein refers to and encompasses any and all possible combinations of the associated listed items. It will also be understood that, although the terms first, second, third, etc., may be used herein to describe various elements, these elements should not be limited by these terms, as these terms are only used to distinguish one element from another unless stated otherwise or the context indicates otherwise.

We claim:

1. A method comprising:
receiving, by a network controller, a runtime signal strength metric indicative of wireless signal power between a first network device and a second network device in a network infrastructure;
receiving, by the network controller, a runtime environmental condition metrics corresponding to one or both of the first network device and the second network device;
determining, by the network controller, a coarse distance between the first network device and the second network device based on the runtime signal strength metric; and
determining, by the network controller, a refined distance between the first network device and the second network device based on the coarse distance and the runtime environmental condition metrics using a machine learning (ML) model, wherein the ML model is trained to infer the refined distance based at least on a set of test environmental condition metrics corresponding to a set of network devices installed at known locations in the network infrastructure.

2. The method of claim 1, wherein the first network device is one of the set of network devices installed at the known locations.

3. The method of claim 1, wherein the runtime environmental condition metrics comprises measures of one or more of humidity, temperature, pressure, or signal absorption by physical objects in the vicinity of one or both of the first network device and the second network device.

4. The method of claim 1, wherein the runtime signal strength metric is a received signal strength indicator (RSSI) determined by the first network device corresponding to the second network device.

5. The method of claim 4, wherein the wireless signal is transmitted in accordance with any of the Bluetooth Standards or the Wireless-Fidelity (Wi-Fi) Standards.

6. The method of claim 2, further comprising determining by the network controller, a location of the second network device based on the refined distance between the first network device and the second network device and a known location of the first network device.

7. The method of claim 1, further comprising training the ML model during a training phase.

8. The method of claim 4, wherein training the ML model comprises:
receiving, by the network controller, a first test signal strength metric between a first network device and a third network device of the set of network devices;
receiving by the network controller, an actual distance between the first network device and the second network device; and
determining, by the network controller, a preliminary distance between the first network device and the third network device based on the first test signal strength metric.

9. The method of claim 8, further comprising:
receiving, by the network controller, the set of test environmental condition metrics corresponding to the first network device and the third network device; and
finetuning, by the network controller, the preliminary distance to generate a finetuned preliminary distance using the ML model, the set of test environmental condition metrics, and a set of ML feature weights;
updating, by the network controller, the set of ML feature weights to generate a set of updated ML feature weights based on a difference between the actual distance and the finetuned preliminary distance; and
storing, by the network controller, the set of updated NN weights.

10. The method of claim 9, wherein determining the refined distance between the first network device and the second network device comprises using the ML model with the set of updated ML feature weights.

11. The method of claim 1, wherein the ML model comprises a neural network or a deep neural network.

12. A network controller comprising:
a processing resource; and
a non-transitory machine-readable storage medium storing instructions executable by the processing resource, wherein the processing resource is configured to execute one or more of the instructions to:
receive, from an access point (AP), a runtime signal strength metric indicative of wireless signal power between the AP and a client device in a network infrastructure;
receive, from the AP, a runtime environmental condition metrics corresponding to one or both of the AP and the client device;
determine a coarse distance between the AP and the client device based on the runtime signal strength metric; and
determine a refined distance between the AP and the client device based on the coarse distance and the runtime environmental condition metrics using a machine learning (ML) model, wherein the ML model is trained to infer the refined distance based at least on a set of test environmental condition metrics corresponding to a set of network devices installed at known locations in the network infrastructure and one or more test signal strength metrics reported by the set of network devices.

13. The network controller of claim 12, wherein the runtime environmental condition metrics comprises measures of one or more of humidity, temperature, pressure, or signal absorption by physical objects in the vicinity of the AP, the client device, or both.

14. The network controller of claim 12, wherein the processing resource is configured to execute one or more of the instructions to determine a location of the client device based on the refined distance and a known location of the AP using a triangulation technique or a trilateration technique, or both.

15. The network controller of claim 12, wherein the processing resource, during a training phase, is configured to execute one or more of the instructions to:
receive a test signal strength metric between a first AP and a second AP of the set of APs;
receive an actual distance between the first AP and the second AP; and
determine a preliminary distance between the first AP and the second AP based on the test signal strength metric.

16. The network controller of claim 15, wherein the processing resource, during a training phase, is configured to execute one or more of the instructions to:
receive the set of test environmental condition metrics corresponding to the first AP and the second AP; and
finetune the preliminary distance to generate a finetuned preliminary distance using the ML model, the set of test environmental condition metrics, and a set of ML feature weights;
update the set of ML feature weights to generate a set of updated ML feature weights based on a difference between the actual distance and the refined distance; and
store the set of updated ML feature weights.

17. The network controller of claim 16, wherein to determine the refined distance the processing resource is configured to execute one or more of the instructions to apply the set of updated ML feature weights to the ML model.

18. A computer-implemented method comprising:
receiving a test signal strength metric between a pair of network devices positioned at known locations in a network infrastructure;
receiving an actual distance between the pair of network devices;
determining a preliminary distance between the pair of network devices based on the test signal strength metric;
finetuning the preliminary distance to generate a finetuned preliminary distance using a neural network, a set of test environmental condition metrics, and a set of neural network weights, wherein the set of test environmental condition metrics comprises measures of one or more of humidity, temperature, pressure, or signal absorption by physical objects;
updating the set of neural network feature weights to generate a set of updated neural network weights based on a difference between the actual distance and the finetuned preliminary distance; and
recording the set of updated neural network weights.

19. The computer-implemented method of claim 18, further comprising:
inferring a distance between a first network device and a second network device located in the network infrastructure using the neural network and the set of updated neural network weights, wherein the first network device is positioned at a known location in the network infrastructure; and
determining a location of the second network device based on the distance between the first network device and the second network device.

20. The computer-implemented method of claim 18, wherein the test signal strength metric is determined by one of the pair of network devices based on a BLE beacon transmitted by the other of the pair of network devices.
